(19) United States
(12) Patent Application Publication
(10) Pub. No.: US 2026/0284579 A1
(43) Pub. Date: Sep. 24, 2026

(54) ACID GAS REMOVAL APPARATUS AND ACID GAS REMOVAL METHOD

(71) Applicants: KABUSHIKI KAISHA TOSHIBA, Kawasaki-shi (JP); TOSHIBA ENERGY SYSTEMS & SOLUTIONS CORPORATION, Kawasaki-shi (JP)

(72) Inventors: Akiko SUZUKI, Ota (JP); Yoshihiko NAKANO, Yokohama (JP); Reiko YOSHIMURA, Kawasaki (JP); Hitomi SAITO, Taito (JP); Asato KONDO, Yokohama (JP); Shinji MURAI, Sagamihara (JP); Takehiko MURAMATSU, Yokohama (JP)

(73) Assignees: KABUSHIKI KAISHA TOSHIBA, Kawasaki-shi (JP); TOSHIBA ENERGY SYSTEMS & SOLUTIONS CORPORATION, Kawasaki-shi (JP)

(21) Appl. No.: 19/546,649

(22) Filed: Feb. 23, 2026

(30) Foreign Application Priority Data
Mar. 19, 2025 (JP) 2025-045932

(51) Int. Cl. B01D 53/14; B01D 53/18; B01D 53/62; B01D 53/78; B01D 53/96

(52) U.S. Cl. CPC B01D 53/1425; B01D 53/1406; B01D 53/1493; B01D 53/18; B01D 53/62; B01D 53/78; B01D 53/96; B01D 2252/202; B01D 2252/20484; B01D 2252/20489; B01D 2252/205; B01D 2252/604; B01D 2257/504

(57) ABSTRACT

The present embodiment provides an apparatus and a method capable of removing acid gas while removing degradation products generated during operation.

There is provided an acid gas removal apparatus according to an embodiment including:
an absorber that brings a gas to be treated into contact with an acid gas absorption liquid to absorb the acid gas in the gas to be treated into the acid gas absorption liquid; and
a regenerator that desorbs the acid gas from the acid gas absorption liquid after acid gas absorption to regenerate the acid gas absorption liquid, in which
a separator that separates a nonionic organic compound contained in the acid gas absorption liquid is further provided, and
the separator brings the acid gas absorption liquid into contact with a hydrophobic medium to selectively extract and separate the nonionic organic compound, which is a degradation product, into the hydrophobic medium.

### CROSS REFERENCE TO RELATED APPLICATIONS

This application is based upon and claims the benefit of priority from the prior Japanese Patent Application No. 2025-045932, filed on Mar. 19, 2025, the entire contents of which are incorporated herein by reference.

### FIELD

Embodiments of the present invention relate to an acid gas removal apparatus and an acid gas removal method.

### BACKGROUND

In recent years, the greenhouse effect caused by the increase in carbon dioxide (CO₂) concentration has been pointed out as one of the causes of global warming, and international measures to protect the environment on a global scale have become an urgent issue. The generation of CO₂ is largely due to industrial activities, and momentum is increasing for the suppression of emission of CO₂ into the environment.

In order to suppress the increase in the concentration of acid gases including CO₂, the development of energy-saving products, the development of technologies for the utilization of acid gases as resources or for their sequestration and storage, and the shift to alternative energies such as natural energy and nuclear energy that do not emit acid gases are being considered, and among these, the technology for separating and recovering emitted acid gases is also being studied.

Acid gas separation technologies that have been studied to date include absorption methods, adsorption methods, membrane separation methods, and cryogenic methods. Among these, the absorption method is suitable and economical for processing large volumes of gas efficiently, and since scaling up of the removal apparatus is easy, application to factories and power plants is being considered.

As a method mainly targeted at thermal power plants that use fossil fuels, a method is known in which exhaust gas generated during the combustion of fossil fuels (such as coal, oil, and natural gas) is brought into contact with an acid gas absorption liquid containing amine compounds such as alkanolamines, represented by monoethanolamine (MEA), to remove and recover CO₂ from the exhaust gas, and furthermore, a method for storing the recovered CO₂ is also known.

For the recovery of CO₂, it is required that the CO₂ absorption step into the acid gas absorption liquid containing amine compounds and the CO₂ desorption step from the acid gas absorption liquid that has absorbed CO₂ (in most cases by heating at 100° C. or higher) are carried out with high efficiency, and that the recovery energy consumed for CO₂ recovery in the process is also low. What becomes a problem in such a CO₂ recovery system is the degradation of the amine compounds due to heating during CO₂ release (recovery). Since exhaust gas (acid gas) contains oxygen, when heated at 100° C. or higher, the amine compounds in the acid gas absorption liquid are oxidized by the oxygen, and it is known that the higher the heating temperature, the more the degradation progresses. The degradation products often include multiple types with differing heat resistance and ionic properties, and with each repetition of the absorption and release cycle, the degradation of the amine compounds progresses, and the degradation products accumulate in the acid gas absorption liquid. For this reason, the repeated use of the acid gas absorption liquid can lead to a decrease in the concentration of amine compounds, which may become a factor in the gradual decrease of CO₂ absorption performance.

### BRIEF DESCRIPTION OF THE DRAWINGS

FIG. 1 is a schematic view of an acid gas removal apparatus according to an embodiment;

FIG. 2 is a view for describing the principle of separating a nonionic organic compound from an acid gas absorption liquid by a solvent extraction method; and

FIG. 3 is a schematic view of an acid gas removal apparatus according to another embodiment.

### DETAILED DESCRIPTION

An object of the present embodiment is to provide an acid gas removal apparatus and an acid gas removal method capable of separating and removing a degradation product with high efficiency.

The embodiment provided by the present invention is as follows: in acid gas removal treatment, nonionic organic compounds such as degraded amine compounds that are generated and do not form salts with acidic molecules are separated from the acid gas absorption liquid by solvent extraction.

According to the present embodiment, there is provided an acid gas removal apparatus including:
an absorber that brings a gas to be treated containing acid gas into contact with an acid gas absorption liquid containing an amine compound to absorb the acid gas in the gas to be treated into the acid gas absorption liquid; and
a regenerator that desorbs the acid gas from the acid gas absorption liquid after acid gas absorption to regenerate the acid gas absorption liquid, in which
the acid gas absorption liquid regenerated by the regenerator is reused in the absorber,
the acid gas removal apparatus further comprises a separator that separates a nonionic organic compound contained in the acid gas absorption liquid after acid gas absorption from the acid gas absorption liquid, and
the separator brings at least a part of the acid gas absorption liquid after acid gas absorption into contact with a hydrophobic medium, extracts the nonionic organic compound into the hydrophobic medium to separate the nonionic organic compound from the acid gas absorption liquid, and is capable of supplying the acid gas absorption liquid after separation to the regenerator.

According to the present embodiment, there is provided an acid gas removal method including:
an absorption step of bringing a gas to be treated containing acid gas into contact with an acid gas absorption liquid containing an amine compound to absorb the acid gas in the gas to be treated into the acid gas absorption liquid; and
a regeneration step of desorbing the acid gas from the acid gas absorption liquid after acid gas absorption to regenerate the acid gas absorption liquid, in which
the acid gas absorption liquid regenerated in the regeneration step is reused in the absorption step,
the acid gas removal method further comprises a separation step of separating a nonionic organic compound contained in the acid gas absorption liquid treated in the acid gas absorption step from the acid gas absorption liquid, and
the separation step brings at least a part of the acid gas absorption liquid treated in the absorption step into contact with a hydrophobic medium, extracts the nonionic organic compound into the hydrophobic medium to separate the nonionic organic compound from the acid gas absorption liquid, and subjects the separated acidic gas absorption liquid to the regeneration step.

According to the present embodiment, there is provided a separator that separates a nonionic organic compound contained in an acid gas absorption liquid after acid gas absorption from the acid gas absorption liquid, in which
at least a part of the acid gas absorption liquid is brought into contact with a hydrophobic medium, and the nonionic organic compound is extracted into the hydrophobic medium and separated from the acid gas absorption liquid.

Embodiments will now be explained with reference to the accompanying drawings.

In the following embodiment, a case where the acid gas is carbon dioxide will be described as an example, but the acid gas removal apparatus and the acid gas removal method according to the embodiment of the present invention can obtain the same effect with respect to other acid gases such as hydrogen sulfide.

The acid gas removal apparatus in the present embodiment is obtained by combining a conventionally known acid gas removal apparatus with a separator for separating and removing a degradation product generated in an acid gas absorption liquid by operation. Hereinafter, an acid gas removal apparatus according to an embodiment will be described.

### <Acid Gas Removal Apparatus>

An acid gas removal apparatus according to an embodiment includes:
an absorber that brings a gas to be treated containing an acid gas into contact with an acid gas absorption liquid containing an amine compound to absorb the acid gas in the gas to be treated into the acid gas absorption liquid; and
a regenerator that desorbs an acid gas from an acid gas absorption liquid after acid gas absorption to regenerate the acid gas absorption liquid. Then, the acid gas absorption liquid absorbs the acid gas in the absorber, the acid gas absorption liquid having absorbed the acid gas is introduced into the regenerator and regenerated, and the regenerated acid gas absorption liquid is introduced into the absorber and reused.

The acid gas removal apparatus according to the embodiment further includes a separator that separates the nonionic organic compound contained in the acid gas absorption liquid after acid gas absorption from the acid gas absorption liquid. This nonionic organic compound is a degradation product generated in the acid gas absorption liquid.

The separator has a function of bringing at least a part of the acid gas absorption liquid that has absorbed the acid gas in contact with the acid gas in the absorber, into contact with the hydrophobic medium. Here, the acid gas absorption liquid contains a nonionic organic compound generated in the process of removing the acid gas, but this nonionic organic compound is eluted into a hydrophobic medium. Since the hydrophobic medium does not dissolve with the acid gas absorption liquid containing water as a main component, the hydrophobic medium is separated into two liquids, for example, when the hydrophobic medium is left to stand, and as a result, the nonionic organic compound can be separated from the acid gas absorption liquid to the outside of the system. The separator separates at least a part of the nonionic organic compound contained in the acid gas absorption liquid. Such separation is an application of a so-called solvent extraction method. In this manner, the acid gas absorption liquid after the nonionic organic compound is separated by the separator can be supplied to the regenerator.

Such an acid gas removal apparatus will be described below with reference to the drawings.

FIG. 1 is a schematic view of an acid gas removal apparatus according to an embodiment.

An acid gas removal apparatus 1 includes an absorber 2 that brings a gas containing an acid gas (for example, exhaust gas) into contact with an acid gas absorption liquid and absorbs and removes the acid gas from the gas containing the acid gas, and a regenerator 3 that separates the acid gas from the acid gas absorption liquid that has absorbed the acid gas and regenerates the acid gas absorption liquid. Hereinafter, a case where the acid gas is carbon dioxide will be described as an example.

As shown in FIG. 1, exhaust gas containing carbon dioxide such as combustion exhaust gas discharged from a thermal power plant or the like is guided to the lower portion of the absorber 2 through a gas supply port 4. The exhaust gas is pushed into the absorber 2 and comes into contact with the acid gas absorption liquid supplied from an acid gas absorption liquid supply port 5 in the upper portion of the absorber 2.

As described above, when the exhaust gas comes into contact with the acid gas absorption liquid, carbon dioxide in the exhaust gas is absorbed and removed by the acid gas absorption liquid. The exhaust gas from which the carbon dioxide has been removed is discharged from a gas discharge port 6 to the outside of the absorber 2.

The acid gas absorption liquid having absorbed carbon dioxide is fed to a heat exchanger 7 and further fed to the regenerator 3. Here, the driving force of liquid feeding can be performed by a rich liquid pump 8.

The acid gas absorption liquid fed into the regenerator 3 moves from the upper portion to the lower portion of the regenerator 3, and during this time, the acid gas in the acid gas absorption liquid is desorbed, and the acid gas absorption liquid is regenerated.

The acid gas absorption liquid regenerated by the regenerator 3 is fed to the heat exchanger 7 and an absorption liquid cooler 10 by a lean liquid pump 9, and returned from the acid gas absorption liquid supply port 5 to the absorber 2.

On the other hand, the acid gas separated from the acid gas absorption liquid comes into contact with the reflux water supplied from a reflux drum 11 in the upper portion of the regenerator 3, and is discharged to the outside of the regenerator 3.

The reflux water in which the carbon dioxide is dissolved is cooled by a reflux cooler 12, and then separated from the liquid component in which the water vapor accompanied with the carbon dioxide is condensed in the reflux drum 11. This liquid component is guided to the acid gas recovery step by a recovery acid gas line 13. On the other hand, the reflux water from which the acid gas has been separated is fed to the regenerator 3.

One of the features of the acid gas removal apparatus 1 according to the embodiment is that the acid gas removal apparatus 1 includes a separator A in addition to the apparatus having the above-described configuration.

In FIG. 1, the separator A is provided between the absorber 2 and the regenerator 3, and a part of the acid gas absorption liquid derived from the absorber 2 passes through the separator A, and the acid gas absorption liquid treated in the separator A is introduced into the regenerator 3. However, the separator A is not necessarily disposed between the absorber 2 and the regenerator 3, and can be disposed, for example, between the absorber 2 and the heat exchanger 7. The separator A may be disposed in the middle of the path through which the time the acid gas absorbing liquid derived from the regenerator 3 is introduced into the absorber 2.

In the acid gas removal apparatus shown in FIG. 1, the acid gas absorption liquid is fed to the regenerator 3 through the separator A once. However, a part of the acid gas absorption liquid that has passed through the separator A can be circulated and supplied to the separator A again. With such a configuration, the nonionic organic compound can be efficiently separated from the acid gas.

Also by arranging a plurality of separators A in series, it is possible to efficiently separate the nonionic organic compound from the acid gas.

Next, a function and a structure of the separator A will be described.

In the acid gas removal method using an acid gas absorption liquid containing an amine compound, a reaction formula when the regenerated gas absorption liquid absorbs CO₂ is as follows.

### Carbamate Anion Generation Mechanism

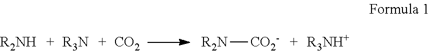

### Bicarbonate Ion Generation Mechanism

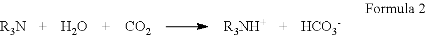

All the salts (ions) generated by the reaction mechanisms represented by Formula 1 and Formula 2 are hydrophilic. The amine compound that is contained in the acid gas absorption liquid and absorbs the acid gas becomes a salt with the acid gas and the amine compound by, for example, a reaction mechanism represented by Formula 1 or Formula 2.

On the other hand, the acid gas absorption liquid includes, for example, a degradation product generated by an oxidation reaction. The degradation product includes a nonionic (hydrophobic) compound. The degradation product is formed by oxidizing the amine compound contained in the acid gas absorption liquid, and thus is generally a nitrogen-containing compound. The nonionic degradation products are usually non-charged molecules. When the acid gas absorption liquid absorbs CO₂, the nonionic degradation product is less likely to be charged than an amine compound that forms a salt by the reaction mechanism. The term “non-charged molecule” includes both a case where the molecule is not charged and a case where it is difficult to be charged. The separator A in the embodiment has a function of removing such a nonionic organic compound. As a method for removing the nonionic organic compound, a solvent extraction method is used in the present embodiment. In the present embodiment, being nonionic means that, for example, a pka is 8 or less. In the present embodiment, the acid dissociation constant (pKa) is a value in water at 25° C. In the present embodiment, the acid dissociation constant (pKa) is a value indicating ease of formation of a base. Here, the pKa of the compound can be known from pKa (predicted, most basic temperature: 25° C.) registered in SciFinder (registered trademark).

Incidentally, the nonionic organic compound which is a degradation product is a nitrogen-containing compound generated from an amine, and is generally a nitro-based, aldehyde-based, amide-based, ketone-based, or ester-based nitrogen-containing compound. Specific examples include N-[2-(methyleneamino)ethyl] formamide (6.04), N-2-(hydroxyethyl) formamide (−0.68), 1-nitrosopiperidine (−3.17), 1,4-dimethylpiperazine (7.99), 1,4-diformylpiperazine (1.26), 2,5-pyrrolidinedione (−4.44), piperazin-2-one (7.74), 4-(2-hydroxyethyl) piperazin-2-one (7.38), 3-ethyl-2-oxazolidone (−1.34), and 2-imidazolidinone (−0.059). The value shown in the parentheses is the acid dissociation constant (pKa) of each compound.

The embodiment utilizes a solvent extraction method, and the removal of the nonionic organic compound by this solvent extraction method is as follows. The solvent extraction method is a method generally used for separating a specific component from other components, and can separate a component that is easily soluble in water and a component that is easily soluble in an organic solvent using a hydrophobic medium phase-separated from water, for example, an organic solvent.

The acid gas absorption liquid used in the acid gas removal method is generally an aqueous solution obtained by mixing an amine compound and water, and the amine compound that is well soluble in water is often used. In addition, the degradation products generated by the operation are often present in a state of being dissolved in the absorption liquid. Examples of the degradation product include a non-charged product such as a nonionic organic compound and a charged product such as a thermally stable salt.

When the acid gas absorption liquid containing such a degradation product is brought into contact with the hydrophobic medium, the non-charged degradation product, for example, the nonionic organic compound is extracted into the hydrophobic medium and excluded from the acid gas absorption liquid. Therefore, the present embodiment is effective for removing degradation products that are not charged. In the present embodiment, the hydrophobic medium extracts at least a part of the nonionic organic compound contained in the acid gas absorption liquid.

However, the amine compound contained in the regenerated gas absorption liquid is also soluble in the hydrophobic medium in many cases. Therefore, a part of the amine compound may also be extracted into the hydrophobic medium, and as a result, loss of the amine compound is likely to occur. In order to improve such a point, it is effective to ionize the amine compound in the acid gas absorption liquid. Specifically, when the acid gas is absorbed into the acid gas absorption liquid, the acid gas and the amine compound react with each other to form a salt, which has ionicity, the affinity for the acid gas absorption liquid is increased, and thus the ionized amine compound is hardly extracted into the hydrophobic medium.

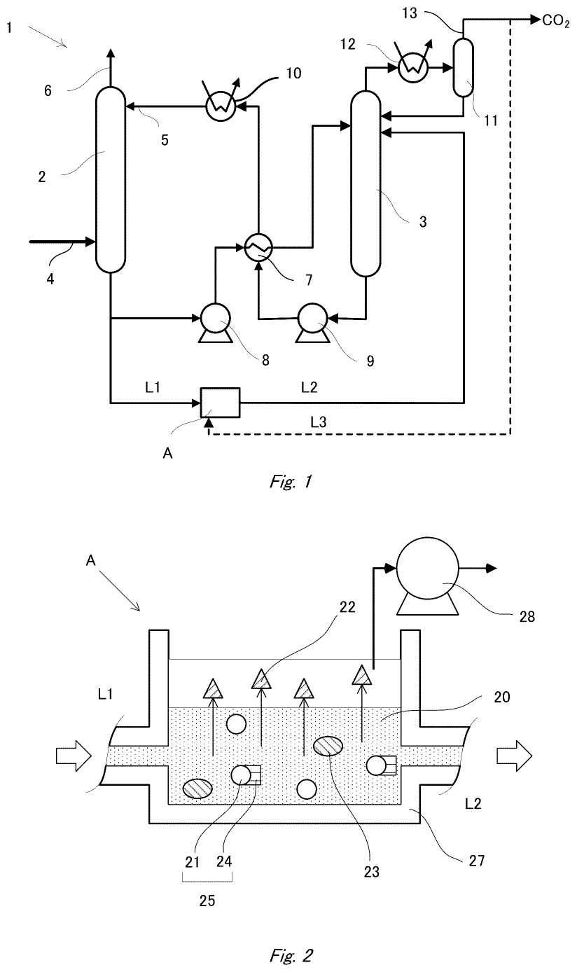

Further, in the acid gas absorption liquid in which the acid gas has been absorbed, the number of molecules having a charge in the system increases and the ionic strength increases, and thus, it is considered that the nonionic degradation product is more easily removed from the aqueous phase. The principle of separating the nonionic organic compound as a degradation product from the acid gas absorption liquid by such extraction is as shown in FIG. 2. An acid gas absorption liquid 20 introduced from an introduction line L1 into a container 27 of the separator A contains an amine compound 21. When the acid gas absorption liquid 20 is circularly used, a nonionic organic compound 22 as a degradation product and a thermally stable salt 23 having relatively high ionicity are generated. A part of the amine compound forms salt 25 bonded to acid gas 24.

When the acid gas absorption liquid 20 comes into contact with the hydrophobic medium 26, the nonionic organic compound 22 is selectively extracted into the hydrophobic medium 26. The highly ionic thermally stable salt 23 and the salt 25 remain in the acid gas absorption liquid. The amine compound may be extracted into the hydrophobic medium 26 alone, but the extraction into the hydrophobic medium can be suppressed by bringing the acid gas absorption liquid into contact with the acid gas in the absorber 2, and as necessary, by introducing the acid gas into the acid gas absorption liquid at the preceding stage of the separator A to change the amine compound into the salt 25. The acid gas absorbent from which the nonionic organic compound has been removed is derived from L2 and can be introduced, for example, into the regenerator 3.

In the separator A, as shown in FIG. 2, the hydrophobic medium 26 that is hydrophobic and the acid gas absorption liquid 20 that is hydrophilic may be phase-separated into two phases. For example, the two phases are referred to as a hydrophobic phase and a hydrophilic phase. In this case, for example, the nonionic organic compound 22 contained in the acid gas absorption liquid 20 is selectively extracted into the hydrophobic phase. For example, the highly ionic thermally stable salt 23 and the salt 25 remain in the hydrophilic phase.

The “state of being separated into two phases” described above means that, for example, a boundary between two phases (hydrophobic phase and hydrophilic phase) is in a relationship in which the boundary can be visually confirmed. In the present embodiment, the hydrophobic phase is a phase containing a hydrophobic medium as a main component, and the hydrophilic phase is, for example, a phase containing water contained in an acid gas absorption liquid as a main component. In the case of phase separation, the organic phase and the aqueous phase typically form complete two phases. However, in the present embodiment, even when complete phase separation is not performed, when a boundary between the phases can be confirmed, the organic phase and the aqueous phase are referred to as “two phases”.

Note that the acid gas absorption liquid introduced into the separator A is generally in contact with the acid gas in the absorber A, and the acid gas reacts with the amine compound to form a salt. However, as described above, the less the amount of the amine compound that is not reacted, the more selectively the non-ionic organic compound can be removed. Therefore, the ratio of the amine compound that is not reacted with the acid gas increases in a case where the amount of the acid gas absorption liquid that is fresh immediately after the start of operation or the amount of the acid gas that is in contact with the acid gas absorption liquid in the absorber is small. In such a case, it is preferable to actively introduce the acid gas into the acid gas absorption liquid introduced into the separator A. That is, it is preferable to bring the acid gas into contact with the acid gas absorption liquid before or during separation of the nonionic organic compound from the acid gas absorption liquid in the separator A. The acid gas used in this case may be one filled in a cylinder or the like, or may be an acid gas recovered by the acid gas removal apparatus according to the embodiment. Specifically, as shown in FIG. 1, the acid gas (carbon dioxide) derived from the reflux drum 11 can be introduced into the acid gas absorption liquid at the preceding stage subjected to the extraction treatment in the separator A via a line L3. Separately, a carbon dioxide introduction apparatus may be provided, for example, between the absorber 2 and the separator A. The carbon dioxide introduction apparatus introduces carbon dioxide into the acid gas absorption liquid derived from the absorber 2. Examples of the carbon dioxide introduction apparatus include a tank filled with a gas containing carbon dioxide, an apparatus for bubbling a gas containing carbon dioxide, and an apparatus for dissolving carbon dioxide by pressurizing carbon dioxide into water to be treated.

The treatment of the acid gas absorption liquid in the separator A uses the solvent extraction method as described above. Therefore, it is necessary to separate the hydrophobic medium and the acid gas absorption liquid after bringing the hydrophobic medium and the acid gas absorption liquid into contact with each other, but any suitable method is used for this separation. For example, an apparatus using a coalescer filter, a liquid-liquid extraction apparatus, a continuous solvent extraction apparatus, a countercurrent multistage extraction apparatus, a mixer-settler, or a batch type single-stage extraction apparatus can be used. A method such as static separation or centrifugal separation can also be used, but a method capable of continuous processing is preferable. For example, in a method using a coalescer filter, when a liquid passes through a filtration surface of the filter, a fine hydrophobic medium, that is, oil is aggregated to form large droplets. In the method using the coalescer filter, since liquid-liquid separation can be continuously performed, the method is preferably used when the acid gas removal apparatus according to the embodiment is continuously operated.

For example, when the hydrophobic phase and the hydrophilic phase are separated, the separator A may be provided with a phase separation apparatus 28. The phase separation apparatus 28 discharges one or both of the hydrophobic phase and the hydrophilic phase from the container 25. FIG. 2 shows a case where the phase separation apparatus 28 is a pump that extracts a hydrophobic phase from the upper side of the container 25. The phase separation apparatus 28 is not limited to a pump. For example, as the phase separation apparatus 28, the apparatus used for separation described above may be used.

In order to evaluate the separation performance by the separator, when the acid gas absorption liquid having absorbed the acid gas is introduced into the separator, the acid gas absorption liquid may be sampled from the introduction pipe and the discharge pipe of the separator, and the amount of the amine compound (GC purity) may be compared by GC/MS.

For the GC/MS, for example, a gas chromatography mass spectrometer 5975 manufactured by Agilent Technologies Inc. is used. As the measurement conditions, the column can be Rtx-35Amine, the oven temperature can be 40° C., the split ratio can be 20, and the measurement range can be m/z 40 to 550.

The sampled acid gas absorption liquid is diluted 100 times with methanol, and a GC/MS spectrum thereof is measured. From this result, the separation performance can be evaluated by the ratio between the amine compound and the degradation product in the acid gas absorption liquid before passing through the separator and the ratio between the amine compound and the degradation product in the acid gas absorption liquid after passing through the separator.

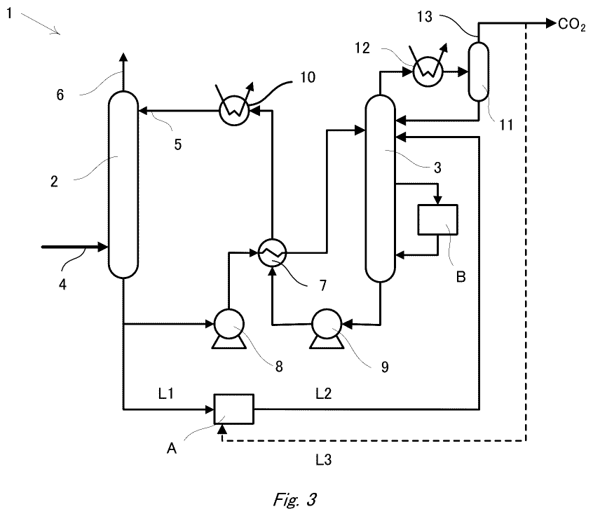

In the present embodiment, the separator A separates a degradation product of the nonionic organic compound. In the present embodiment, as shown in FIG. 3, a thermal reclaimer B can be provided, for example, at a subsequent stage of the regenerator 3. The thermal reclaimer B heats and evaporates the acid gas absorption liquid from which the acid gas has been desorbed by the regenerator, and recovers the heated and evaporated components, and can separate a degradation product such as a thermally stable salt that does not volatilize as a residue. By using the separator A in combination, degradation products can be more effectively separated. In the present embodiment, the nonionic organic compound can also be supplementarily separated by passing the acid gas absorption liquid through a membrane of hydrophobic zeolite or the like.

In the present embodiment, an apparatus using an electrodialysis method may be used in combination as an apparatus for separating degradation products. In the apparatus using the electrodialysis method, hydrophilic degradation products such as thermally stable salts, and water-soluble degradation products can be separated. As an example of the thermally stable salt, there is a thermally stable amine salt generated by an acid gas absorption liquid (containing an amine compound) absorbing an inorganic acid (for example, SOx, NOx, carbonyl sulfide, hydrogen cyanide, thiocyanate, thiosulfate) contained in carbon dioxide exhaust gas. The apparatus using the electrodialysis method can be arranged, for example, between the regenerator 3 and the heat exchanger 7.

### <Method for Removing Acid Gas>

The acid gas removal method according to the present embodiment includes:

an absorption step of bringing a gas to be treated containing an acid gas into contact with an acid gas absorption liquid containing an amine compound to absorb the acid gas in the gas to be treated into the acid gas absorption liquid; and
a regeneration step of desorbing an acid gas from an acid gas absorption liquid after absorption of the acid gas to regenerate the acid gas absorption liquid, and
the acid gas absorption liquid regenerated in the regeneration step is reused in the absorption step.

The acid gas removal method in the present embodiment further includes a separation step of separating the nonionic organic compound contained in the acid gas absorption liquid treated in the acid gas absorption step from the acid gas absorption liquid. In this separation step, at least a part of the acid gas absorption liquid treated in the absorption step is brought into contact with a hydrophobic medium, and the nonionic organic compound is extracted into the hydrophobic medium and separated from the acid gas absorption liquid. The acid gas absorption liquid after separation of the nonionic organic compound is subjected to a regeneration step.

Such an acid gas removal method can be typically performed by the above-described acid gas removal apparatus.

The amine compound used in the acid gas removal method in the embodiment is not particularly limited and may be generally one used for removing an acid gas. In general, alkanolamines represented by monoethanolamine (MEA) and cyclic diamines are known. Such alkanolamines have been developed since the 1930s and are still used today.

Examples of typical alkanolamines used in the absorption method 2-amino-2-methylpropanolamine, methylaminoethanol, include ethylaminoethanol, propylaminoethanol, monoethanolamine, diethanolamine, methyldiethanolamine, dimethylethanolamine, diethylethanolamine, triethanolamine, or dimethylamino-1-methylethanol.

Examples of cyclic diamines include:
piperazine,
1-(2-hydroxyethyl) piperazine,
1-(2-aminoethyl) piperazine,
1,4-bis [3-aminopropyl]piperazine,
N-isopropyldiethanolamine,
N-isopropyldipropanolamine,
N-isopropyldibutanolamine,
N-isopropyldipentanolamine,
N-isopropyldihexanolamine,
3-[(2-hydroxyethyl) (propan-2-yl)amino]propan-1-ol,
4-[(2-hydroxyethyl) (propan-2-yl)amino]butan-1-ol,
5-[(2-hydroxyethyl) (propan-2-yl)amino]pentan-1-ol,
6-[(2-hydroxyethyl) (propan-2-yl)amino]hexan-1-ol,
N-sec-butyldiethanolamine,
N-sec-butyldipropanolamine,
N-sec-butyldibutanolamine,
N-sec-butyldipentanolamine,
N-sec-butyldihexanolamine,
3-[(2-hydroxyethyl) (butan-2-yl)amino]propan-1-ol,
4-[(2-hydroxyethyl) (butan-2-yl)amino]butan-1-ol,
5-[(2-hydroxyethyl) (butan-2-yl)amino]pentan-1-ol,
6-[(2-hydroxyethyl) (butan-2-yl)amino]hexan-1-ol,
N-cyclopentyldiethanolamine,
N-cyclopentyldipropanolamine,
N-cyclopentyldibutanolamine,
N-cyclopentyldipentanolamine,
N-cyclopentyldihexanolamine,
3-[(2-hydroxyethyl) (cyclopentyl)amino]propan-1-ol,
4-[(2-hydroxyethyl) (cyclopentyl)amino]butan-1-ol,
5-[(2-hydroxyethyl) (cyclopentyl)amino]pentan-1-ol,
6-[(2-hydroxyethyl) (cyclopentyl)amino]hexan-1-ol,
2-azetidinemethanol,
2-(2-aminoethyl) azetidine,
2-pyrrolidinemethanol,
2-(2-aminoethyl) pyrrolidine,
2-piperidinemethanol,
3-piperidineethanol,
2-(2-aminoethyl) pyrrolidine,
1-(2-hydroxyethyl) piperazine,
2-(hydroxymethyl) piperazine,
3-hydroxypyrrolidine,
3-pyrrolidinemethanol,
2-(2-hydroxyethyl) pyrrolidine,
4-piperidineethanol,
3-hydroxypiperidine,
4-hydroxypiperidine,
4-(hydroxymethyl) piperidine, and
3-aminopiperidine.

Among these,
piperazine,
1-(2-hydroxyethyl) piperazine,
1-(2-aminoethyl) piperazine,
1,4-bis [3-aminopropyl]piperazine,
N-isopropyldiethanolamine,
N-isopropyldipropanolamine,
3-[(2-hydroxyethyl) (propan-2-yl)amino]propan-1-ol,
N-sec-butyldiethanolamine,
N-sec-butyldipropanolamine,
N-sec-butyldibutanolamine,
3-[(2-hydroxyethyl) (butan-2-yl)amino]propan-1-ol,
N-cyclopentyldiethanolamine,
N-cyclopentyldipropanolamine, and
3-[(2-hydroxyethyl) (cyclopentyl)amino]propan-1-ol
   are preferred.

Furthermore, a cyclic diamine represented by Formula (1a) or (1b) can also be used. These cyclic amines are also preferable.

### [Chemical Formula 1]

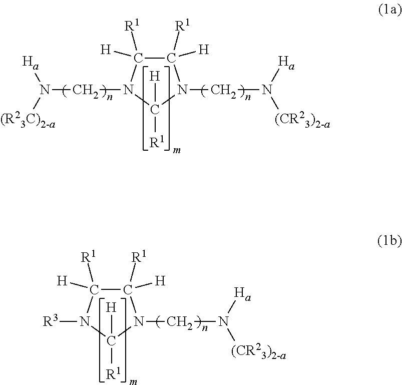

In the formula,
R¹'s are each independently a hydrogen or an unsubstituted or substituted alkyl group having 3 or fewer carbon atoms,
R²'s are each independently a hydrogen or an unsubstituted or substituted alkyl group having 3 or fewer carbon atoms,
among the R²'s included in one —CR²₃, at least two are not hydrogen,
R³'s are a hydrogen or an unsubstituted or substituted alkyl group having 4 or fewer carbon atoms,
a's are each independently 0 or 1,
m is a number from 1 to 3, and
n's are each independently a number from 1 to 4.

More specifically, R¹ and R³ are each independently hydrogen, a methyl group, an ethyl group, a propyl group, or an isopropyl group, and R² is hydrogen, a methyl group, or an ethyl group. m is preferably 2, and n is preferably 2 to 3.

The acid gas absorption liquid in the embodiment may contain an alkanolamine or a cyclic diamine alone, or may contain a combination of two or more thereof, or may contain a combination of two or more cyclic diamines.

The higher the content of the amine compound contained in the acid gas absorption liquid, the larger the amount of carbon dioxide absorbed and desorbed per unit volume, and the higher the rate of carbon dioxide absorbed and desorbed, which is preferable in terms of energy consumption and treatment efficiency. In general, when the content of the amine compound in the acid gas absorption liquid is too high, the viscosity of the absorption liquid tends to increase. From these, the total content of the amine compound is preferably 5 to 60 mass %, and more preferably 10 to 50 mass %, based on the total mass of the acid gas absorption liquid.

In the present embodiment, the acid gas absorbent may further contain an optional component as necessary. Examples of the optional component include an antioxidant, a pH adjusting agent, an antifoaming agent, and an anticorrosive agent.

The antioxidant can prevent degradation of the acid gas absorption liquid and improve the life thereof. Preferable specific examples of the antifoaming agent include a silicone-based antifoaming agent and an organic antifoaming agent. When the antifoaming agent is used, the content based on the total mass of the acid gas absorption liquid is preferably 0.00001 to 0.001 mass %, and particularly preferably 0.0005 to 0.001 mass %.

The antifoaming agent can prevent foaming of the acid gas absorption liquid, suppress a decrease in absorption efficiency and separation efficiency of the acid gas, and prevent a decrease in fluidity or circulation efficiency of the acid gas absorption liquid.

Preferable specific examples of the anticorrosive agent include phosphoric acid esters, tolyltriazoles, and benzotriazoles. When an anticorrosive agent is used, the content based on the total mass of the acid gas absorption liquid is preferably 0.00003 to 0.0008 mass %, and particularly preferably 0.00005 to 0.005 mass %. Such an anticorrosive agent can prevent corrosion of plant equipment and improve the life thereof.

In addition, the hydrophobic medium used in the separation step can be selected and used in any manner from those which do not dissolve each other with an acid gas absorption liquid such as an aqueous solution containing an amine compound and can dissolve a nonionic organic compound. In the hydrophobic medium in the present embodiment, for example, a nonionic organic compound having a pKa of 8 or less contained in an acid gas absorption liquid having absorbed acid gas is more easily dissolved than a salt of an amine compound and an acid gas. The hydrophobic medium is difficult to dissolve with water and may be phase-separated. Examples thereof include aliphatic hydrocarbon-based organic solvents, ether-based organic solvents, aromatic-based organic solvents, amide-based organic solvents, phosphorus-based organic solvents, halogenated hydrocarbons, and mixtures thereof. More specifically, examples include N, N-di-n-octyl-3-oxapentanediamide, sulfolane, tributyl phosphate (TBP), triphenylphosphine oxide (TOPO), 3-methyl-1-butanol, 2-ethylhexyl 2-ethylhexylphosphonate, di-n-hexyl sulfide, thioglycolamide, tri-n-octylphosphine oxide, MIDOA, TODGA, DODGAA, DBDECMP, DHDECMP, HEHEHP, D2EHPA, n-hexane, ethyl acetate, iso-octane, n-heptane, cyclohexane, toluene, chloroform, benzene, dichloromethane, methyl tert-butyl ether, chloroform, carbon tetrachloride, n-butanol, n-amyl alcohol, i-amyl alcohol, cyclohexanol, THF, n-propyl ether, i-propyl ether, methyl isobutyl ketone, n-butyl acetate, i-butyl acetate, n-amyl acetate, diethyl ether, 1,2-dichloroethane, dichlorobenzene, and higher alcohols having 6 to 24 carbon atoms.

A plurality of organic solvents may be mixed and used, and when an extraction solvent of a type that forms a complex with metal ions is used, there is a possibility that metal ions contained in the acid gas absorption liquid can be removed at the same time. Commercially available diluents such as Escaid, Solvesso, Exsol, Shell parabase, Kermac, Chevron and the like may be mixed. The specific gravity of the solvent is better when the difference from the specific gravity of water is large, and efficient separation can be performed. The solubility of the solvent in water is preferably low. Care should be taken because when the hydrophobic medium has a high solubility in water, the hydrophobic medium and the acid gas absorption liquid cannot be separated from each other, which may make it difficult to remove degradation products. Specifically, the compound in the hydrophobic medium has a molar solubility at 25° C. of preferably 1 mol/l or less, more preferably 0.6 mol/l or less in a solvent (for example, water) having a pH of 7. Here, the molar solubility is the number of moles of a solute (here, the compound of the hydrophobic medium) dissolved per 1 L of a saturated solution (solute+solvent (for example, water)). The molar solubility of a compound can be known by SciFinder (registered trademark).

Hereinafter, the present embodiment will be described more specifically with reference to examples, but the conditions in the examples are merely examples adopted to confirm the feasibility and effects of the present embodiment, and the present embodiment is not limited to these condition examples. The present embodiment can adopt various conditions as long as the object of the present embodiment is achieved without departing from the gist of the present embodiment.

### Example 1

As a model of the acid gas absorption liquid, a 30% MEA aqueous amine solution was used, to which 1% of 2-oxazolidone was added as a model of a nonionic organic compound, and this was used as a simulated solution of a degraded acid gas absorption liquid. The simulated solution was diluted with methanol such that the concentration became 100 ppm. After 20 g of the diluted simulated solution was bubbled with 100% CO₂ gas for 100 minutes, solvent extraction was performed with a separating funnel using 20 g of ethyl acetate as a hydrophobic medium. Ethyl acetate to be an oil phase after extraction was diluted with methanol to have a concentration of 100 ppm, and GC/MS was measured. In the obtained spectrum, the case where the area value of the nonionic organic compound exceeded the area value of the MEA was rated as good, and the case where the area value of the MEA was larger than the area value of the nonionic organic compound was rated as bad. The obtained results are summarized in Table 1.

### Example 2

Evaluation was performed under the same conditions as in Example 1, except that the 2-oxazolidone in Example 1 was replaced with N-(2-hydroxyethyl) formamide, and the solvent was changed to diethyl ether.

### Example 3

Evaluation was performed under the same conditions as in Example 1, except that the 2-oxazolidone in Example 1 was replaced with N-(2-hydroxyethyl)glycine, and the solvent was changed to methyl isobutyl ketone.

### Example 4

Evaluation was performed under the same conditions as in Example 1, except that the 2-oxazolidone in Example 1 was replaced with N-(1-methylethyl)-1-piperazineethanamine, and the solvent was changed to cyclohexanol.

### Example 5

Evaluation was performed under the same conditions as in Example 1, except that the 2-oxazolidone in Example 1 was replaced with 2,5-pyrrolidinedione, and the solvent was changed to 3-methyl-1-butanol.

### Example 6

Evaluation was performed under the same conditions as in Example 1, except that the MEA in Example 1 was replaced with 30% MDEA and 10% PZ, the 2-oxazolidone was replaced with 1,4-dimethylpiperazine, and the solvent was changed to diethyl ether. Because of the two components, the sum of the area values of the two components was taken as the area value of the absorption liquid component.

### Example 7

Evaluation was performed under the same conditions as in Example 1, except that the MEA in Example 1 was replaced with 40% HEPZ, and the 2-oxazolidone was replaced with isoamyl alcohol.

### Example 8

Evaluation was performed under the same conditions as in Example 1, except that the MEA in Example 1 was replaced with 40% HEPZ, and the 2-oxazolidone was replaced with N-(1-methylethyl)-1-piperazineethanamine.

### Example 9

Evaluation was performed under the same conditions as in Example 1, except that the MEA in Example 1 was replaced with 30% AEPZ, and the solvent was changed to methyl isobutyl ketone.

### Example 10

Evaluation was performed under the same conditions as in Example 1, except that the MEA in Example 1 was replaced with 40% EAE.

### Reference Example 1

Evaluation was performed under the same conditions as in Example 1, except that the operation of introducing 100% CO₂ gas in Example 1 was omitted.

TABLE 1

| | Type and | | | | | |
|---|---|---|---|---|---|---|
| | concentration of | | Type of | | GC/MS Evaluation | |
| | amine compound | Type of nonionic | hydrophobic | CO2 | Before | After |
| | (wt %) | organic compound | medium | bubbling | extraction | extraction |
| Example 1 | MEA(30%) | 2-Oxazolidone | Ethyl acetate | Yes | Not | Good |
| | | | | | detectable | |
| Example 2 | MEA(30%) | N-(2- | Diethyl ether | Yes | Not | Good |
| | | Hydroxyethyl)formamide | | | detectable | |
| Example 3 | MEA(30%) | N-(2- | Methyl | Yes | Not | Good |
| | | Hydroxyethyl)glycine | isobutyl ketone | | detectable | |
| Example 4 | MEA(30%) | N-(1-Methylethyl)-1- | Cyclohexanol | Yes | Not | Good |
| | | piperazineethanamine | | | detectable | |
| Example 5 | MEA(30%) | 2,5-Pyrrolidinedione | 3-Methyl-1- | Yes | Not | Good |
| | | | butanol | | detectable | |
| Example 6 | MEA(30%), | 1,4-Dimethylpiperazine | Diethyl ether | Yes | Not | Good |
| | PZ(10%) | | | | detectable | |
| Example 7 | HEPZ(40%) | 2-Oxazolidone | Isoamyl alcohol | Yes | Not | Good |
| | | | | | detectable | |
| Example 8 | HEPZ(40%) | N-(1-Methylethyl)-1- | Ethyl acetate | Yes | Not | Good |
| | | piperazineethanamine | | | detectable | |
| Example 9 | AEPZ(30%) | 2-Oxazolidone | Methyl | Yes | Not | Good |
| | | | isobutyl ketone | | detectable | |
| Example 10 | EAE(40%) | 2-Oxazolidone | Ethyl acetate | Yes | Not | Good |
| | | | | | detectable | |
| Reference | MEA(30%) | 2-Oxazolidone | Ethyl acetate | No | Not | Not |
| Example1 | | | | | detectable | detectable |

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fail within the scope and sprit of the invention.
1 Acid gas removal apparatus
2 Absorber
3 Regenerator
4 Gas supply port
5 Acid gas absorption liquid supply port
6 Gas discharge port
7 Heat exchanger
8 Rich liquid pump
9 Lean liquid pump
10 Absorption liquid cooler
11 Reflux drum
12 Reflux cooler
13 Recovery acid gas line
L1 Introduction line
L2 Derivation line
20 Acid gas absorption liquid
21 Amine compound
22 Nonionic organic compound
23 Thermally stable salt
24 Acid gas
25 Salt
26 Hydrophobic medium
27 Container
A Separator
B Thermal reclaimer

1. An acid gas removal apparatus comprising:
an absorber that brings a gas to be treated containing acid gas into contact with an acid gas absorption liquid containing an amine compound to absorb the acid gas in the gas to be treated into the acid gas absorption liquid; and
a regenerator that desorbs the acid gas from the acid gas absorption liquid after acid gas absorption to regenerate the acid gas absorption liquid, wherein
the acid gas absorption liquid regenerated by the regenerator is reused in the absorber,
the acid gas removal apparatus further comprises a separator that separates a nonionic organic compound contained in the acid gas absorption liquid after acid gas absorption from the acid gas absorption liquid, and
the separator brings at least a part of the acid gas absorption liquid after acid gas absorption into contact with a hydrophobic medium, extracts the nonionic organic compound into the hydrophobic medium to separate the nonionic organic compound from the acid gas absorption liquid, and is capable of supplying the acid gas absorption liquid after separation to the regenerator.

2. The acid gas removal apparatus according to claim 1, wherein the hydrophobic medium is an organic solvent.

3. The acid gas removal apparatus according to claim 2, wherein the organic solvent is selected from the group consisting of an aromatic hydrocarbon compound, a hydrocarbon compound, a halogenated hydrocarbon compound, an alcohol, and a diglycol amide compound.

4. The acid gas removal apparatus according to claim 1, wherein the acid gas absorption liquid after the nonionic organic compound is separated by the separator contains a salt of an amine compound and an acid gas.

5. The acid gas removal apparatus according to claim 1, wherein the nonionic organic compound contains a nitrogen-containing compound.

6. The acid gas removal apparatus according to claim 1, wherein the nonionic organic compound is a non-charged molecule.

7. The acid gas removal apparatus according to claim 1, wherein the separator is disposed between the absorber and the regenerator.

8. The acid gas removal apparatus according to claim 1, further comprising an apparatus that brings carbon dioxide into contact with the acid gas absorption liquid after the acid gas absorption at a preceding stage of the separator.

9. The acid gas removal apparatus according to claim 1, further comprising a thermal reclaimer.

10. The acid gas removal apparatus according to claim 1, wherein a part of the acid gas absorption liquid after the nonionic organic compound is separated by the separator is circularly supplied to the separating apparatus before being introduced into the regenerator.

11. The acid gas removal apparatus according to claim 1, wherein a plurality of the separators are disposed in series.

12. An acid gas removal method comprising:
an absorption step of bringing a gas to be treated containing acid gas into contact with an acid gas absorption liquid containing an amine compound to absorb the acid gas in the gas to be treated into the acid gas absorption liquid; and
a regeneration step of desorbing the acid gas from the acid gas absorption liquid after acid gas absorption to regenerate the acid gas absorption liquid, wherein
the acid gas absorption liquid regenerated in the regeneration step is reused in the absorption step,
the acid gas removal method further comprises a separation step of separating a nonionic organic compound contained in the acid gas absorption liquid treated in the acid gas absorption step from the acid gas absorption liquid, and
the separation step brings at least a part of the acid gas absorption liquid treated in the absorption step into contact with a hydrophobic medium, extracts the nonionic organic compound into the hydrophobic medium to separate the nonionic organic compound from the acid gas absorption liquid, and subjects the separated acidic gas absorption liquid to the regeneration step.

13. (a) The acid gas removal method according to claim 12, wherein the absorption step is performed at 60° C. or lower.

14. (b) The acid gas removal method according to claim 12, wherein the regeneration step is performed at 70° C. or higher.

15. A separator that separates a nonionic organic compound contained in an acid gas absorption liquid after acid gas absorption from the acid gas absorption liquid, wherein
at least a part of the acid gas absorption liquid is brought into contact with a hydrophobic medium, and the nonionic organic compound is extracted into the hydrophobic medium and separated from the acid gas absorption liquid.
